(19) United States
(12) Patent Application Publication
(10) Pub. No.: US 2024/0375434 A1
(43) Pub. Date: Nov. 14, 2024

(54) WHEEL HUB SYSTEM

(71) Applicant: Virginia Beach Products LLC, Virginia Beach, VA (US)

(72) Inventor: Afram M. Kotto, Virginia Beach, VA (US)

(73) Assignee: Virginia Beach Products LLC, Virginia Beach, VA (US)

(21) Appl. No.: 18/662,830

(22) Filed: May 13, 2024

Related U.S. Application Data
(60) Provisional application No. 63/465,594, filed on May 11, 2023.

(51) Int. Cl. B60B 27/06

(52) U.S. Cl. CPC B60B 27/065

(57) ABSTRACT

A wheel hub assembly is presented by this disclosure. In one exemplary embodiment, a wheel hub apparatus includes a wheel assembly having front and back bushing plate assemblies. Each bushing plate assembly includes a cover plate attached to a bushing structure. Further, the bushing structure includes an axel aperture, positioning ridges, semi-circular notches, and bolt apertures. Each semi-circular notch corresponds to one of the bolt apertures and is configured to receive and position a bolt in that bolt aperture so that the corresponding bushing plate assembly is rotationally secured to that bolt. The apparatus further includes a wheel hub having front and back wheel hub assemblies and configured to secure a tire. Also, each wheel hub assembly includes a flanged portion forming a cavity with a wheel assembly seat positioned at the center of the cavity and configured to receive the corresponding wheel assembly.

### CROSS REFERENCE TO RELATED APPLICATIONS

This application claims the benefit of U.S. Provisional App. No. 63/465,594, filed May 11, 2023, which is hereby incorporated by reference as if fully set forth herein.

### FIELD OF DISCLOSURE

The present disclosure relates generally to the field of wheels, and in particular to a wheel hub system that facilitates rotation of a wheel and a tire about an axle.

### BACKGROUND

As technology and materials have improved so have the capabilities and functionality of the wheel. For instance, vehicle and airplane wheels continue to be developed to withstand greater forces as well as to perform for longer durations. One important element towards the evolution of wheel technology has been the design of the wheel and axle interface. The ability of a wheel and tire to rotate efficiently depends on the combined actions of the wheel and axle.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1A-1B are perspective exploded views of one embodiment of a wheel hub system in accordance with various aspects as described herein.

FIGS. 2A-2D provide various views of the wheel hub system of FIGS. 1A-1B. FIG. 2A is a side view of the wheel hub system of FIGS. 1A-1B. FIG. 2B is a transversal cross-sectional view of section A-A of the wheel hub system of FIG. 2A. FIG. 2C is a front view of the wheel hub system of FIGS. 1A-1B. FIG. 2D is a longitudinal cross-sectional view of section B-B of the wheel hub system of FIG. 2C.

FIGS. 3A-3E provide respective front, front perspective, side, back, and back perspective views of the bushing plate assemblies of FIGS. 1A-1B.

FIG. 4A-4B provide front and side views of the tire of FIG. 1A.

### DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

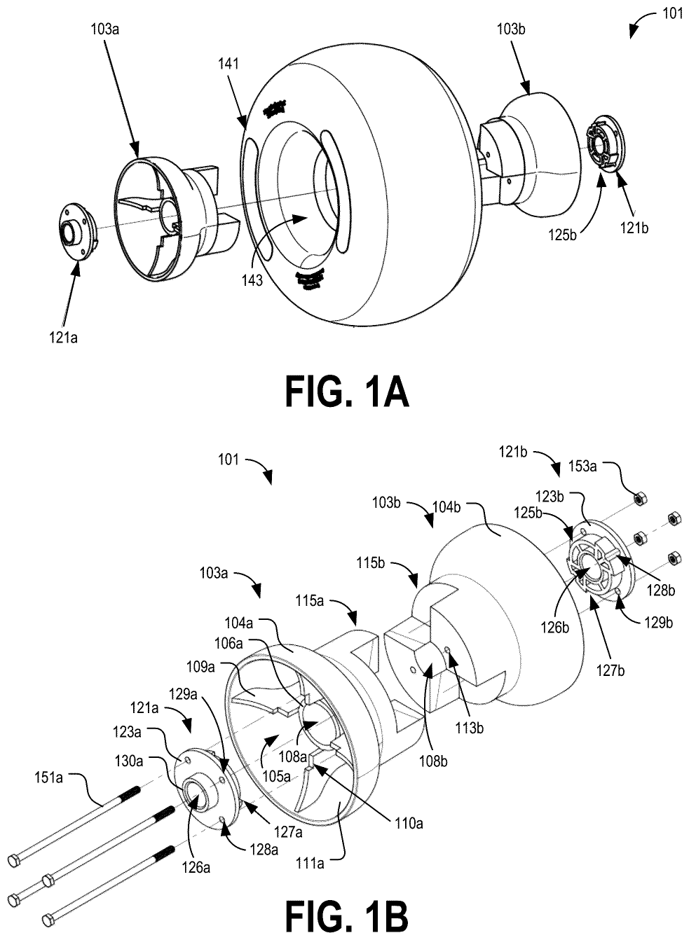

In this disclosure, a wheel hub system and apparatus that facilitates rotation of a corresponding tire about an axle are provided. In one example, FIG. 1A-1B are perspective exploded views of one embodiment of a wheel hub system or apparatus 101 in accordance with various aspects as described herein. The wheel hub system 101 can include a wheel assembly having front and back bushing plate assemblies 121a,b. Each bushing plate assembly 121a,b can include a cover plate 123a,b coupled to a bushing structure 125a,b. In one example, the cover plate 123a,b and the bushing structure 125a,b form a single fixed structure so as to provide more rigidity over a separate cover plate and bushing structure. The bushing structure 125a,b can include an axel aperture 126a,b, positioning ridges 127a,b, semi-circular notches 128a,b, bolt apertures 129a,b, the like, or any combination thereof. Each semi-circular notch 128a,b can correspond to one of the bolt apertures 129a,b and can be configured to receive and position a bolt 151a in that bolt aperture 129a,b so that the corresponding bushing plate assembly 121a,b is rotationally secured to that bolt 151a. A nut 153a can be secured onto the end of each inserted bolt 151a to securely couple the wheel hub apparatus 101.

In FIGS. 1A-1B, the wheel hub system 101 can also include a wheel hub having front and back wheel hub assemblies 103a,b and can be configured to secure a tire 141. Each wheel hub assembly 103a,b can include a flanged portion 104a,b forming a cavity 105a,b, a wheel assembly seat 106a,b positioned at the center 107a,b of the cavity, the like, or any combination thereof. The wheel assembly seat 106a,b can be configured to receive the corresponding bushing plate assembly 121a,b. The wheel assembly seat 106a,b can include an axel aperture 108a,b longitudinally disposed through the body of the wheel hub assembly 103a,b at the center of the cavity 105a,b, arms 109a,b that radially extend from the seat 106a,b to a surface 111a,b of the cavity 105a,b, bolt apertures 113a,b circumferentially disposed about the seat, the like, or any combination thereof. Each arm 109a,b can include a positioning notch 110a,b circumferentially positioned about the seat 106a,b. Further, each bushing plate assembly 121a,b can be configured to be disposed in the seat 106a,b of the corresponding wheel hub assembly 103a,b with the positioning notches 110a,b of that wheel hub assembly 121a,b being adjoined with and rotationally secured to the positioning ridges 127a,b of that bushing plate assembly 121a,b such that the bolt apertures 113a,b, 129a,b and axle apertures 108a,b, 126a,b of the wheel hub assemblies 103a,b and the bushing plate assemblies 121a,b align so as to enable a bolt 151a to be inserted through those bolt apertures 113a,b, 129a,b to secure the wheel hub system 101.

In the current embodiment, the wheel hub system 101 is configured to position the front and back wheel hub assemblies 103a,b at opposing sides of a tire aperture 143 so as to secure the tire 141 to the wheel hub system 101. In one example, the tire is an inflatable rubber tire. In another example, the tire is a balloon tire. In yet another example, the tire is a wide (e.g., 5 to 12 inches), large-volume (e.g., 80 to 150 cubic inches), low-pressure (e.g., 1 to 10 PSI) tire. The hub system 101 is configured to facilitate bidirectional rotation of the hub system 101 and the tire 141 about an axle (not shown). Each of the front and back wheel hub assemblies 103a,b can be disposed in a tire aperture 143 from opposing sides of the tire aperture 143 such that the wheel hub assemblies 103a,b are interlockingly attached and secured to the tire so as to facilitate bidirectional tire and wheel rotation about an axle. In one example, the wheel hub system 101 can be configured to position the front and back wheel hub assemblies 103a,b at opposing sides of the tire aperture 143 so that the front and back wheel hub assemblies 103a,b are rotationally offset by ninety degrees. In another example, the wheel hub system is configured to position the front and back wheel hub assemblies 103a,b at opposing sides of the tire aperture 143 so that the front and back wheel hub assemblies 103a,b are rotationally offset by zero degrees. A first interlocking member 115a can be a mirror image of a second interlocking member 115b and the first and second interlocking members can be fitted together by means of selectively joining the first and second members 115a,b so as to interlock the first and second members 115a,b.

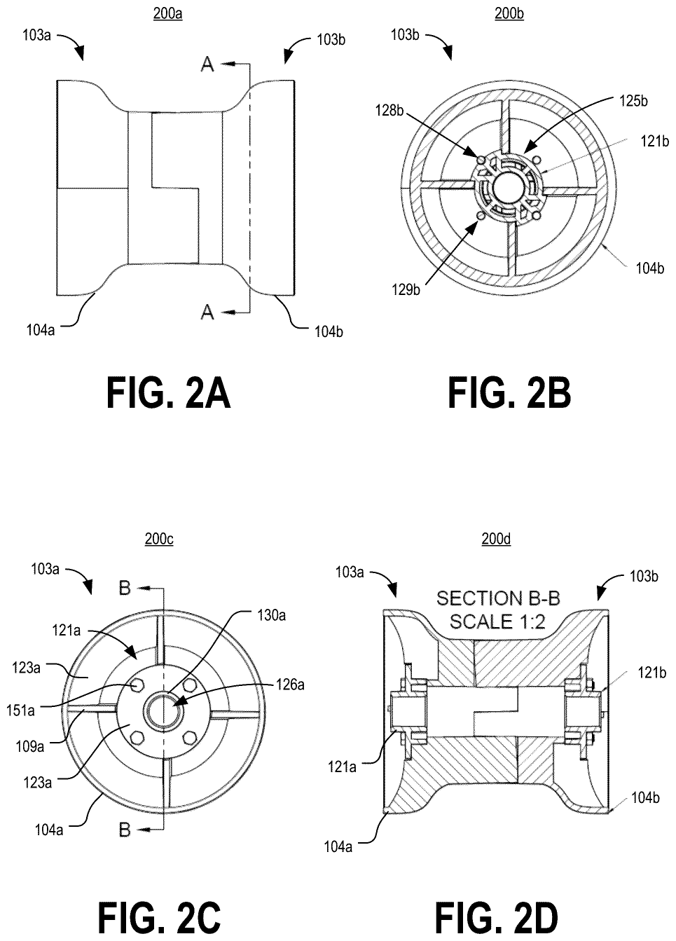

FIGS. 2A-2D provide various views of the wheel hub system 101 of FIGS. 1A-1B. FIG. 2A is a side view of the wheel hub system 101 of FIGS. 1A-1B. FIG. 2B is a transversal cross-sectional view of section A-A of the wheel hub system 101 of FIG. 2A. FIG. 2C is a front view of the wheel hub system 101 of FIGS. 1A-1B. FIG. 2D is a longitudinal cross-sectional view of section B-B of the wheel hub system 101 of FIG. 2C.

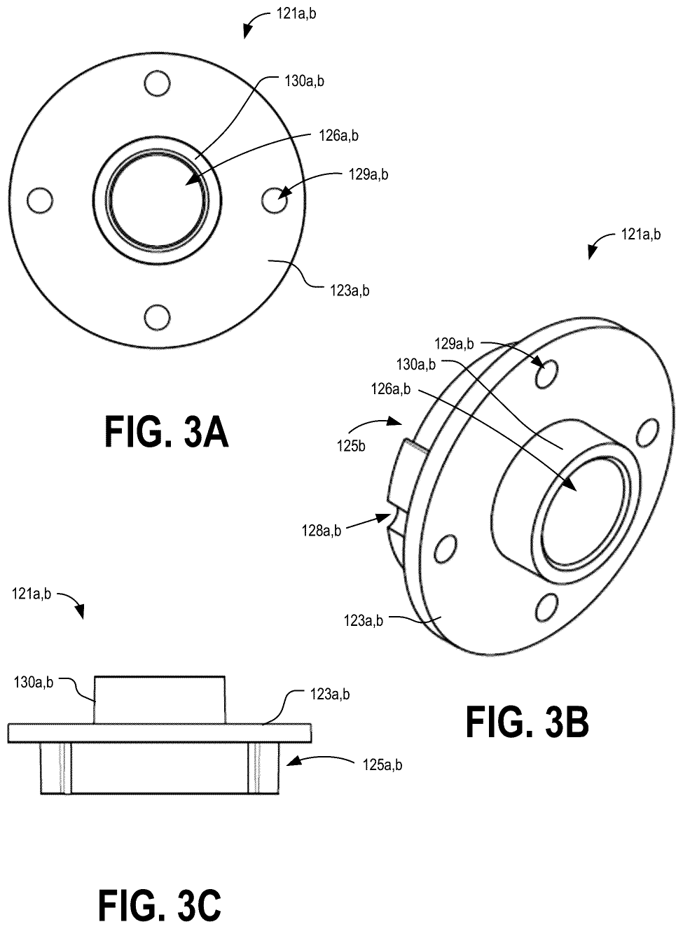

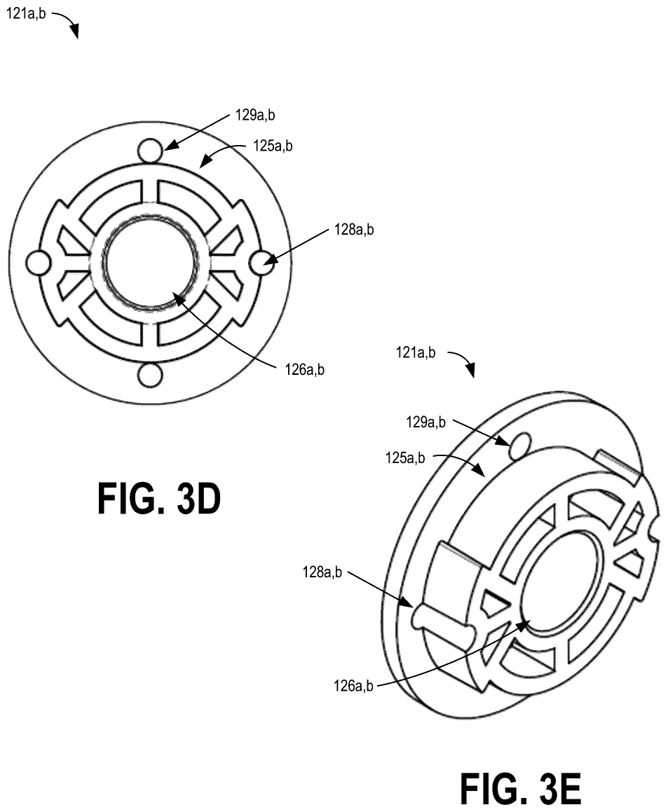

FIGS. 3A-3E provide respective front, front perspective, side, back, and back perspective views of the bushing plate assemblies 121a,b of FIGS. 1A-1B.

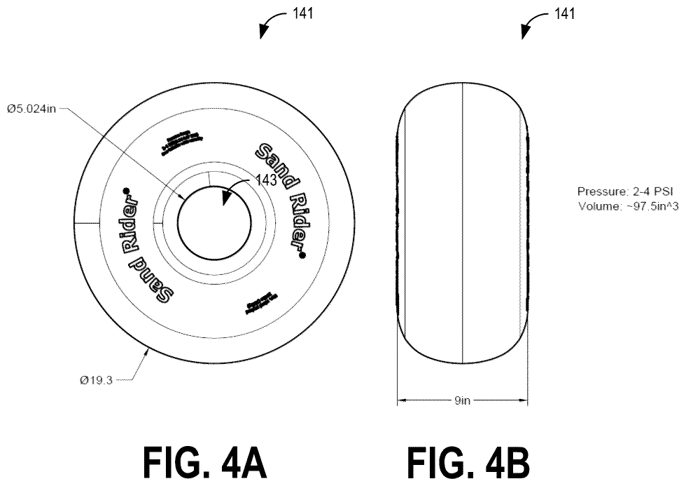

FIG. 4A-4B provide front and side views of the tire 141 having the tire aperture 143 of FIG. 1A.

In one exemplary embodiment, an apparatus includes a wheel assembly having front and back bushing plate assemblies. Each bushing plate assembly has a cover plate attached to a bushing structure. Further, the bushing structure has an axel aperture, positioning ridges, semi-circular notches, and bolt apertures. Each semi-circular notch corresponds to one of the bolt apertures and is configured to receive and position a bolt in that bolt aperture so that the corresponding bushing plate assembly is rotationally secured to that bolt. The apparatus further includes a wheel hub having front and back wheel hub assemblies and is configured to secure a tire having a tire aperture. Each wheel hub assembly has a flanged portion forming a cavity with a wheel assembly seat positioned at the center of the cavity and is configured to receive the corresponding wheel assembly. Also, the seat has an axel aperture disposed at the center of the cavity, arms that radially extend from the seat to the surface of the cavity, and bolt apertures circumferentially disposed about the seat. Each arm has a positioning notch circumferentially positioned about the seat. Each bushing plate assembly is configured to be disposed in the seat of the corresponding wheel hub assembly with the positioning notches of that wheel hub assembly being adjoined with and rotationally secured to the positioning ridges of that bushing plate assembly such that the bolt and axle apertures of the bushing plate assemblies and the wheel hub assemblies align so as to enable a bolt to be inserted through those bolt apertures to secure the wheel hub system.

In another exemplary embodiment, the bushing structure can have two semi-circular notches and each bushing plate assembly and wheel hub assembly can have four bolt apertures.

In another exemplary embodiment, the apparatus can be configured to insert an axel through the corresponding axle apertures of the bushing plate assemblies and the wheel hub assemblies.

In another exemplary embodiment, a nut can be secured onto an end of each inserted bolt.

In another exemplary embodiment, the apparatus can be configured to insert an axle through the axle apertures of the bushing plate assemblies and the wheel hub assemblies so as to facilitate rotation of the wheel hub about the axle.

In another exemplary embodiment, the apparatus can be configured to position the front and back wheel hub assemblies at opposing sides of a tire aperture so as to secure the tire to the hub system.

In another exemplary embodiment, the apparatus can be configured to position the front and back wheel hub assemblies at opposing sides of a tire aperture so that the front and back wheel hub assemblies are rotationally offset by ninety degrees.

In another exemplary embodiment, the tire can be an inflatable rubber tire.

In another exemplary embodiment, the tire can have a width of at least five inches.

In one exemplary embodiment, a method includes inserting a bolt through corresponding bolt apertures of the bushing plate assemblies and the wheel hub assemblies of the apparatus as described herein.

In one exemplary embodiment, a method includes inserting an axle through axle apertures of the bushing plate assemblies and the wheel hub assemblies of the apparatus as described herein.

In one exemplary embodiment, a system includes a tire having a tire aperture and a wheel assembly having front and back bushing plate assemblies. Each bushing plate assembly has a cover plate attached to a bushing structure. Further, the bushing structure has an axel aperture, positioning ridges, semi-circular notches, and bolt apertures. Each semi-circular notch corresponds to one of the bolt apertures and is configured to receive and position a bolt in that bolt aperture so that the corresponding bushing plate assembly is rotationally secured to that bolt. The system further includes a wheel hub having front and back wheel hub assemblies and configured to secure the tire. Each wheel hub assembly has a flanged portion forming a cavity with a wheel assembly seat positioned at the center of the cavity and configured to receive the corresponding wheel assembly. Also, the seat has an axel aperture disposed at the center of the cavity, arms that radially extend from the seat to the surface of the cavity, and bolt apertures circumferentially disposed about the seat. Each arm has a positioning notch circumferentially positioned about the seat. Each bushing plate assembly is configured to be disposed in the seat of the corresponding wheel hub assembly with the positioning notches of that wheel hub assembly being adjoined with and rotationally secured to the positioning ridges of that bushing plate assembly such that the bolt and axle apertures of the bushing plate assemblies and the wheel hub assemblies align so as to enable a bolt to be inserted through those bolt apertures to secure the wheel hub system.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A wheel hub apparatus, comprising:
a wheel assembly having front and back bushing plate assemblies, with each bushing plate assembly having a cover plate attached to a bushing structure, with the bushing structure having an axel aperture, positioning ridges, semi-circular notches, and bolt apertures, with each semi-circular notch corresponding to one of the bolt apertures and being configured to receive and position a bolt in that bolt aperture so that the corresponding bushing plate assembly is rotationally secured to that bolt;
a wheel hub having front and back wheel hub assemblies and configured to secure a tire, with each wheel hub assembly having a flanged portion forming a cavity with a wheel assembly seat positioned at a center of the cavity and configured to receive the corresponding wheel assembly, the seat having an axel aperture disposed at the center of the cavity, arms that radially extend from the seat to a surface of the cavity, and bolt apertures circumferentially disposed about the seat, with each arm having a positioning notch circumferentially positioned about the seat; and
wherein each bushing plate assembly is configured to be disposed in the seat of the corresponding wheel hub assembly with the positioning notches of that wheel hub assembly being adjoined with and rotationally secured to the positioning ridges of that bushing plate assembly such that the bolt and axle apertures of the bushing plate assemblies and the wheel hub assemblies align so as to enable a bolt to be inserted through those bolt apertures to secure the wheel hub system.

2. The apparatus of claim 1, wherein the bushing structure has two semi-circular notches and each bushing plate assembly and wheel hub assembly has four bolt apertures.

3. The apparatus of claim 1, wherein the wheel hub system is configured to insert an axel through the corresponding axle apertures of the bushing plate assemblies and the wheel hub assemblies.

4. The apparatus of claim 1, wherein a nut is secured onto an end of each inserted bolt.

5. The apparatus of claim 1, wherein the wheel hub system is configured to insert an axle through the axle apertures of the bushing plate assemblies and the wheel hub assemblies so as to facilitate rotation of the wheel hub about the axle.

6. The apparatus of claim 1, wherein the wheel hub system is configured to position the front and back wheel hub assemblies at opposing sides of a tire aperture so as to secure the tire to the hub system.

7. The apparatus of claim 1, wherein the wheel hub system is configured to position the front and back wheel hub assemblies at opposing sides of a tire aperture so that the front and back wheel hub assemblies are rotationally offset by ninety degrees.

8. The apparatus of claim 1, wherein the tire is an inflatable rubber tire.

9. The apparatus of claim 8, wherein the tire has a width of at least five inches.

10. A method, comprising:
inserting a bolt through corresponding bolt apertures of the bushing plate assemblies and the wheel hub assemblies of the apparatus of claims 1-9.

11. A system, comprising:
a tire having a tire aperture;
a wheel assembly having front and back bushing plate assemblies, with each bushing plate assembly having a cover plate attached to a bushing structure, with the bushing structure having an axel aperture, positioning ridges, semi-circular notches, and bolt apertures, with each semi-circular notch corresponding to one of the bolt apertures and being configured to receive and position a bolt in that bolt aperture so that the corresponding bushing plate assembly is rotationally secured to that bolt;
a wheel hub having front and back wheel hub assemblies and configured to secure the tire, with each wheel hub assembly having a flanged portion forming a cavity with a wheel assembly seat positioned at a center of the cavity and configured to receive the corresponding wheel assembly, the seat having an axel aperture disposed at the center of the cavity, arms that radially extend from the seat to a surface of the cavity, and bolt apertures circumferentially disposed about the seat, with each arm having a positioning notch circumferentially positioned about the seat; and
wherein each bushing plate assembly is configured to be disposed in the seat of the corresponding wheel hub assembly with the positioning notches of that wheel hub assembly being adjoined with and rotationally secured to the positioning ridges of that bushing plate assembly such that the bolt and axle apertures of the bushing plate assemblies and the wheel hub assemblies align so as to enable a bolt to be inserted through those bolt apertures to secure the wheel hub system.

12. The system of claim 11, wherein the bushing structure has two semi-circular notches and each bushing plate assembly and wheel hub assembly has four bolt apertures.

13. The system of claim 11, wherein the system is configured to insert an axel through the corresponding axle apertures of the bushing plate assemblies and the wheel hub assemblies.

14. The system of claim 11, wherein a nut is secured onto an end of each inserted bolt.

15. The system of claim 11, wherein the system is configured to insert an axle through the axle apertures of the bushing plate assemblies and the wheel hub assemblies so as to facilitate rotation of the wheel hub about the axle.

16. The system of claim 11, wherein the system is configured to position the front and back wheel hub assemblies at opposing sides of the tire aperture so as to secure the tire to the hub system.

17. The system of claim 11, wherein the system is configured to position the front and back wheel hub assemblies at opposing sides of the tire aperture so that the front and back wheel hub assemblies are rotationally offset by ninety degrees.

18. The system of claim 11, wherein the tire is an inflatable rubber tire.

19. The system of claim 18, wherein the tire has a width of at least five inches.
